(19) United States
(12) Patent Application Publication
(10) Pub. No.: US 2026/0321077 A1
(43) Pub. Date: Oct. 15, 2026

(54) METHOD OF INSPECTING A PASSENGER CONVEYANCE SYSTEM OF A BUILDING; USER INTERFACE FOR AN END DEVICE; AND END DEVICE

(71) Applicant: Otis Elevator Company, Farmington, CT (US)

(72) Inventor: Gabriel Vaudour, Mardié (FR)

(21) Appl. No.: 19/406,272

(22) Filed: Dec. 2, 2025

(30) Foreign Application Priority Data
Apr. 11, 2025 (EP) 25305522.2

(51) Int. Cl. G07C 9/00; B66B 5/00

(52) U.S. Cl. CPC G07C 9/00309; B66B 5/0087; G07C 9/00563; G07C 2009/00317

(57) ABSTRACT

A method of inspecting a passenger conveyance system (100) of a building, including: a) authorization of a person for conducting the inspection, a data connection between an end device (200) and a control device (120) of the passenger conveyance system (100) is established and an authentication of the person is performed by using an equipment of the end device (200); and b) after a successful identification of the person by means of the authorization in step a), enabling of an inspection mode of the passenger conveyance system (100).

### FOREIGN PRIORITY

This application claims priority to European Patent Application No. 25305522.2, filed Apr. 11, 2025, and all the benefits accruing therefrom under 35 U.S.C. § 119, the contents of which in its entirety are herein incorporated by reference.

### TECHNICAL FIELD OF INVENTION

The present disclosure relates to a method of inspecting a passenger conveyance system of a building and a user interface for an end device, like a smartphone, NFC key, NFC connected watch, etc. The present disclosure also relates to an end device.

### BACKGROUND OF THE INVENTION

It is generally known that, for security reasons, an inspection mode (or a maintenance mode) of a passenger conveyance system is activated by means of a dedicated mechanical key switch placed on the Car Operational Panel (COP, also called as the control panel thereafter) of the passenger conveyance system. In these years, it also has been carried out by other technologies like Barre code/QR Code scanned on a physical support or a smartphone. However, these codes can become unrecognisable over time; misuse by unauthorised persons is also possible. Here, the passenger conveyance system includes elevator, escalator and walkalator (or moving walkway) systems.

In this respect, it is an object of the present disclosure to provide a method of inspecting a passenger conveyance system of a building, a user interface for an end device and an end device.

### SUMMARY OF THE INVENTION

According to an aspect, a method of inspecting a passenger conveyance system of a building, comprises: a) authorization of a person for conducting the inspection, wherein a data connection between an end device and a control device of the passenger conveyance system is established and an authentication of the person is performed by using an equipment of the end device; and b) after a successful identification of the person by means of the authorization in step a), enabling of an inspection mode of the passenger conveyance system.

Here, the passenger conveyance system includes elevator, escalator and walkalator (or moving walkway) systems and so on. By means of the above method of the present disclosure, a very strong security access to control the passenger conveyance system is provided, particularly when the mode of the passenger conveyance system is switched. Moreover, maintenance processes can also be traced.

According to an aspect, the control device comprises a control panel and the data connection is established when placing the end device near the control panel. It makes it more convenient for the person to bring the end device close to the control device in the passenger conveyance system.

According to an aspect, in step a) the control device establishes a connection to an external database in order to compare the actual information of the person recorded by the equipment of the end device with information stored in the external database. Since the information of the persons who have access to inspect the passenger conveyance system is stored in the external database in advance, the person whose information is stored in the eternal database would be quickly identified and other person would not be identified successfully. Therefore, the security can be strengthened.

According to an aspect, the control device can further record the trace of the person, when it connects to the external database. In this manner, all the information that the person tries to get access or gets access to inspect the passenger conveyance system and switches the passenger conveyance system back to the service mode and so on can be recorded in the external database. For example, it can be carried out the user management, registration of use time (for example, date, hour, minutes, etc.) when the passenger conveyance system switches between the different modes.

According to an aspect, from the inspection mode back to a service mode, step a) has to be carried out again, and after the successful identification of the person, the mode of the passenger conveyance system is switched into the service mode. In this manner, it can prevent some other person who does not have access to control the passenger conveyance system from switching the mode of the passenger conveyance system, and thus can ensure the person under inspection to be in a safe working situation.

According to an aspect, after one successful identification of the person, the person is permitted to switch freely between different modes of the passenger conveyance system comprising the inspection mode and a service mode. It enables the authorized person to control the passenger conveyance system quickly to save working time.

According to an aspect, the control device is capable of establishing a bridging connection between a key element (an additional key element besides the end device connectable via the data connection) and the control device that allows skipping the authentication of the person based on the data connection. It provides an alternative solution to control the passenger conveyance system, when the end device does not work due to some reasons.

According to an aspect, the data connection is a NFC-, WiFi-, LiFi-, RFID-, Zigbee-, zWave- or Bluetooth-connection or other similar connection. In fact, in the present disclosure any one of these similar data connections may be used. Since such data connection may be established in a relative short distance, it can prevent to some extent any other devices from casually connecting to the passenger conveyance system.

According to an aspect, a method of inspecting a passenger conveyance system of a building may comprise: a1) connecting an end device with a control device of the passenger conveyance system via a data connection; b1) the end device being authorized to switch between different modes of the passenger conveyance system. In this manner, the end device can be connected to the passenger conveyance system so as to enable the passenger conveyance system to be switched between the different modes without the authentication of the person who uses the end device. According to an aspect, the present disclosure provides a user interface for an end device, like a smartphone, an NFC key, an NFC connected watch or other similar device. The user interface is provided to be connected with a control device of a passenger conveyance system to be inspected via a data connection and is provided to perform an authorization of a person for conducting the inspection comprising an authentication of the person by using an equipment of the end device. In this manner, mechanical key switches can be completely replaced by the end device with the above user interface. At the same time, the security access to control the passenger conveyance system is further strengthened.

### BRIEF DESCRIPTION OF THE DRAWINGS

Embodiments of the present disclosure, as an example only, will be described in the following with reference to the drawings. In the drawings:

FIG. 1 schematically illustrates a flow chart of a method of inspecting a passenger conveyance system of a building according to the present disclosure;

FIG. 2 schematically illustrates an example of the present disclosure, wherein the NFC connection may be established between a smartphone and a control panel of the elevator system combined with facial verification or be established between a key element and a control panel in the control device of the elevator system; and

FIG. 3 schematically illustrates a block diagram of an end device with a user interface prepared for working together with a passenger conveyance system.

### DETAILED DESCRIPTION OF THE INVENTION

In the following, embodiments of the present disclosure are explained with reference to the drawings. The same elements are assigned the same reference numbers in the drawings. It is to be noted that the embodiments are described for exemplary purposes only and the description of the embodiments is not intended to limit the scope of the present disclosure.

Usually, a passenger conveyance system 100 in a building can be operated in a service mode (or a normal operation mode) and an inspection mode (or a maintenance mode). In the service mode, the passenger conveyance system 100 works properly to transport the passengers to the different floors. In the inspection mode, the passenger conveyance system 100 stops transporting the passengers and the relevant persons, for example, the maintenance persons, perform inspection or maintenance on it. Of course, the passenger conveyance system 100 may have further or different modes according to its design.

Due to security concerns, only some specific persons can have access to inspect the passenger conveyance system 100. In general, such persons should be authorized in advance. The present disclosure provides a method of inspecting an passenger conveyance system 100 of a building so that only permitted persons can get access to control the passenger conveyance system 100.

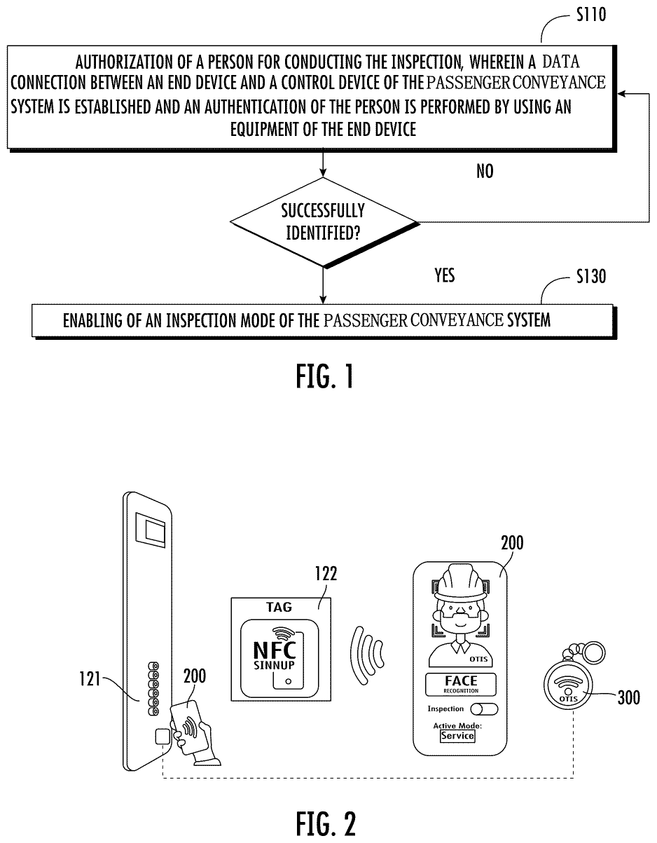

FIG. 1 schematically illustrates a flow chart of a method of inspecting the passenger conveyance system 100 of a building according to the present disclosure. The method of inspecting the passenger conveyance system 100 comprises:
Step S110: authorization of the person for conducting the inspection, wherein a data connection between an end device 200 and a control device 120 of the passenger conveyance system 100 is established and an authentication of the person is performed by using an equipment of the end device 200; and
Step S130: after a successful identification of the person by means of the authorization in step 110), enabling of an inspection mode of the passenger conveyance system 100.

The end device 200 can be any kind of a mobile terminal, like a smartphone, a tablet, a connected watch, etc. As usual, the end device 200, which is used to connect with the passenger conveyance system 100, can only be accessible to some specific persons. However, there is still a possibility that someone, who does not have right to use the end device 200, gets access to the end device 200. Therefore, in the present disclosure, in order to strengthen the security, in step 110, a data connection between the end device 200 and the control device 120 should be established.

Here, both the end device 200 and the control device 120 are each provided with a data connection chip respectively, such as a chip used for NFC-, WiFi-, LiFi-, RFID-, Zigbee-, zWave- or Bluetooth-connection, so that a data connection can be established therebetween when the end device 200 is placed close enough (here at a distance of 4 cm or less) to the control device 120. The data connection chip is usually built in the respective device (end device 200 and control device 120) for wireless communication therebetween.

In step S110, an authentication of the person has to be performed by using an equipment of the end device 200. Here, the equipment of the end device 200 may be one component built in or integrated into the end device 200, like a camera or a fingerprint sensor and so on. For authenticating the facial or biometric feature(s) of the person is identified by the end device 200.

As shown in FIG. 1, if the person is not identified successfully, he/she will not be authorized to control the passenger conveyance system 100 to conduct the inspection. The person could then start again the authentication. If the person is identified successfully, he/she is authorized to control the passenger conveyance system 100. The passenger conveyance system 100 is enabled to be switched into the inspection mode in step S130.

It should be noted that, in the above method, the sequence of establishing the data connection and performing the authentication/identification of the person is not fixed. It is preferred to perform the authentication of the person first and then to establish the data connection. However, the reverse process is also possible, that is to establish the data connection first and then perform the authentication/identification of the person.

With other words the control device 120 of the passenger conveyance system 100 can comprise a control panel 121, for example, in a car of an elevator system 100. A data connection chip can be built/integrated in the control panel 121 of the control device 120. In this manner, in the above step S110, the data connection is established after the end device 200 is placed near the control panel 121. It is more convenient for the person to bring the end device 200 close to the control panel 121 in the elevator system 100. The data connection can be established easily and successfully when the end device 200 has to be approached to the control device 120 at less than 10 cm, better less than 4 cm.

Optionally, a data connection tag is provided on the surface of the control panel 121 to indicate the correct position where the end device 200 has to be positioned/aligned with the data connection chip of the control panel 121. In this case, the person can clearly recognize where to place the end device 200 to establish the data connection with the elevator system 100 quickly and surely.

As can also be seen with the concrete embodiment of FIG. 2, a smartphone as the end device 200 is used by a person, such as a maintenance person, to establish the NFC connection with the control panel 121 in the car of the elevator system 100. The NFC tag 122 is set on the surface of the control panel 121 to indicate the place of the NFC chip in the control panel 121.

When the person places the smartphone close enough to the NFC tag 122, the NFC connection between the smartphone and the control device 120 is established. The screen of the smartphone displays the currently activated mode of the elevator system 100 (here the service mode). When the person wants to switch the current service mode to the inspection mode, he/she has to pass the identification of facial features by means of the camera of the smartphone. When he/she is identified successfully, he/she can operate the button on the screen of the smartphone to switch the current service mode to the inspection mode. When he/she is not identified successfully, he/she cannot control the elevator system 100.

Optionally, in step S110, the control device 120 may establish a connection to an external database in order to compare the actual information of the person recorded by the equipment of the end device 200 with information stored in the external database when the authentication of the person is performed. Here, the information of the persons who have access to inspect the passenger conveyance system 100 is stored in the external database in advance. When one of these persons is authenticated by means of the camera of the smartphone, he/she is be finally identified successfully. When the person whose facial features are not stored in the external database in advance, he/she will not be identified successfully and then he/she can not control the passenger conveyance system 100 to do the inspection work.

In addition, in order to further strengthen the security, facial or biometric identification/verification such as HYPR can be used in the present disclosure. In this way, every person should be identified/verified every time when he/she wants to inspect the passenger conveyance system 100.

Optionally, when the passenger conveyance system 100 may be switched from the inspection mode back to the service mode, the above step 110) has to be carried out again. After finally identifying the person successfully, the mode of the passenger conveyance system 100 can be switched into the service mode. In this manner, it can prevent some other person who does not have access to control the passenger conveyance system 100 from switching the mode of the passenger conveyance system 100, and thus ensure the person under inspection to be in a safe working situation.

Alternatively, after one successful identification of the person, the person may be permitted to switch freely between different modes of the passenger conveyance system 100 comprising the inspection mode and the service mode. Here, it should be noted that the passenger conveyance system 100 maybe has other different modes according to its design. For example, in one design of the passenger conveyance system 100, the inspection mode can be same as the maintenance mode. However, in other design of the passenger conveyance system 100, the inspection mode may be for inspecting the condition of the passenger conveyance system 100 routinely, and the maintenance mode may be for performing maintenance of the passenger conveyance system 100 when the passenger conveyance system 100 is malfunctioning. The present disclosure does not limit the modes of the passenger conveyance system 100.

In practice, in order to ensure that the above method of the present disclosure can be properly executed, for example, in an elevator system, the persons who have access to the end device 200 can perform the following processes regularly, for example, one time a day:
Step 1: carrying out the above steps S110 and S130, enabling the elevator system 100 to be switched into the inspection mode, and then pushing a landing button on the control panel 121 to check that the car of the elevator system 100 does not move;
Step 2: carrying out the above steps S110 and S130, enabling the elevator system 100 to be switched into the service mode, and then pushing a landing button on the control panel 121 to check that the car of the elevator system 100 moves; and
Step 3: carrying out the above steps S110 and S130, enabling the elevator system 100 to be switched into the inspection mode again, and then pushing a landing button on the control panel 121 to check that the car of the elevator system 100 does not move.

The other passenger conveyance system such as an escalator or a moving walkway system can also be checked regularly so as to ensure the above method of the present disclosure can be properly executed.

Furthermore, the control device 120 is capable of establishing a bridging connection to a key element 300. Here, the key element 300 can have a builtin or integrated data connection chip, like an electronic key via NFC shown in FIG. 2, so that a data connection between the control device 120 and the key element 300 can be established. Nevertheless, the key element 300 here can replace the end device 200 when the end device 200 is not available or can not be used. In this case, the identification of the person via the camera or the fingerprint sensor can be skipped. That is to say, when the end device 200, for example, the key element 300 is connected with the control device 120 of the passenger conveyance system 100, the end device 200 is authorized to switch the passenger conveyance system between its different modes.

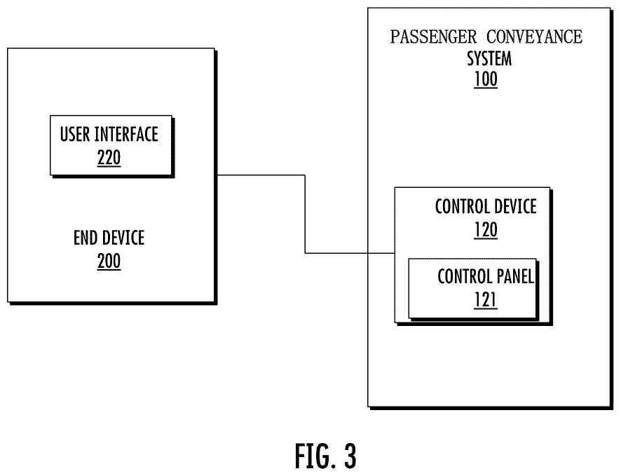

It should be noted that, while the preceding explanations were primarily made by using the elevator system as an example, the present disclosure also equally applies to the escalator system, the moving walkways system and other similar system. The present disclosure further provides a user interface 220 for the end device 200, like a smartphone. As indicated in FIG. 3, the user interface 220 is provided to be connected with a control device 120 of an passenger conveyance system 100 to be inspected via an data connection and is provided to perform an authorization of a person for conducting the inspection comprising an authentication of the person by using an equipment of the end device 200, like a camera or a fingerprint sensor. In addition, the user interface 220 may also be configured to execute the method above.

The present disclosure further relates to the end device 200 itself. The end device 200 comprises the above mentioned user interface 220.

What is claimed is:

1. Method of inspecting a passenger conveyance system (100) of a building, comprising:
a) authorization of a person for conducting the inspection, wherein a data connection between an end device (200) and a control device (120) of the passenger conveyance system (100) is established and an authentication of the person is performed by using an equipment of the end device (200); and
b) after a successful identification of the person by means of the authorization in step a), enabling of an inspection mode of the passenger conveyance system (100).

2. Method according to claim 1, wherein the control device (120) comprises a control panel (121) and the data connection is established when placing the end device (200) near the control panel (121).

3. Method according to claim 1, wherein in step a) the control device (120) establishes a connection to an external database in order to compare the actual information of the person recorded by the equipment of the end device (200) with information stored in the external database.

4. Method according to claim 3, wherein the control device (120) further records the trace of the person, when it connects to the external database.

5. Method according to claim 1, wherein from the inspection mode back to a service mode, step a) has to be carried out again, and after the successful identification of the person, the mode of the passenger conveyance system (100) is switched into the service mode.

6. Method according to claim 1, wherein after one successful identification of the person, the person is permitted to switch freely between different modes of the passenger conveyance system (100) comprising the inspection mode and a service mode.

7. Method according to claim 1, wherein the control device (120) is capable of establishing a bridging connection between a key element (300) and the control device (120) that allows skipping the authentication of the person.

8. Method according to claim 1, wherein the data connection is a NFC-, WiFi-, LiFi-, RFID-, Zigbee-, zWave- or Bluetooth-connection.

9. Method of inspecting a passenger conveyance system (100) of a building, comprising:
a1) connecting an end device with a control device of the passenger conveyance system (100) via a data connection;
b1) the end device being authorized to switch between different modes of the passenger conveyance system (100).

10. User interface (220) for an end device (200), including one of a smartphone, an NFC key, an NFC connected watch, wherein the user interface (220) is provided to be connected with a control device (120) of a passenger conveyance system (100) to be inspected via an data connection and is provided to perform an authorization of a person for conducting the inspection comprising an authentication of the person by using an equipment of the end device (200).

11. End device, comprises a user interface (220) according to claim 10.
